(19) United States
(12) Patent Application Publication
(10) Pub. No.: US 2019/0128683 A1
(43) Pub. Date: May 2, 2019

(54) VEHICLE LOCATION SYSTEM AND METHOD

(71) Applicant: Ford Global Technologies, LLC, Dearborn, MI (US)

(72) Inventors: Johannes Geir KRISTINSSON, Ann Arbor, MI (US); Shiqi QIU, Canton, MI (US); Ryan Abraham MCGEE, Shanghai (CN); Jun LONG, Dearborn, MI (US)

(73) Assignee: Ford Global Technologies, LLC, Dearborn, MI (US)

(21) Appl. No.: 16/093,730

(22) PCT Filed: Apr. 15, 2016
(86) PCT No.: PCT/US16/27883

§ 371 Date: Oct. 15, 2018

(51) Int. Cl. G01C 21/34; G06Q 50/30; G01C 21/36; H04W 4/024; H04W 4/40

(52) U.S. Cl. CPC G01C 21/3438; G06Q 50/30; G01C 21/3415; B60W 10/04; H04W 4/024; H04W 4/40; G01C 21/3626

(57) ABSTRACT

A system of one or more computers configured to perform operations or actions by virtue of having software, firmware, hardware, or a combination installed on the system which causes the system to perform actions. One or more computer programs can be configured to perform operations or actions by virtue of including instructions that cause the apparatus to perform the actions. One general aspect includes a system, including a computer programmed to receive a pickup request with a current location of a rider. The system determine a route to the rider, based on a geolocation of a vehicle and the location of the rider. The system receives updated locations from the rider, and updates the route to the rider for the driver. Other embodiments of this aspect include corresponding computer systems, apparatus, and computer programs recorded on one or more computer storage devices, each configured to perform the actions of the methods.

### BACKGROUND

Autonomous and semiautonomous vehicles could be sent to a pickup location to pick up a rider and transport the rider to a destination. However, the rider may not be familiar with the pickup location and could have difficulty locating the pickup location and/or the pickup vehicle itself. Further, livery service providers and/or other vehicle operators may find it difficult to locate the rider in some scenarios. For example, a parent picking up a child at a crowed venue can find it difficult to locate the child.

### BRIEF DESCRIPTION OF THE DRAWINGS

FIG. 1 is a block diagram of an exemplary vehicle location system.

FIG. 2 is a flowchart of an exemplary process that may be implemented in a vehicle computer and associated hardware components of the system of FIG. 1.

FIG. 3 is a flowchart of another exemplary process that may be implemented in a vehicle computer and associated hardware components of the system of FIG. 1.

### DESCRIPTION

A vehicle computer can receive, e.g., from a rider's smartphone or the like, a rider's request for a ride along with a geolocation of the rider. The rider's request can be sent from a communication device, for example, a mobile device, a smartphone, a portable computer or a wearable device, etc. A driver confirms the rider's request for the ride and determines at least one route to the rider using the vehicle's navigation system. After the rider receives the confirmation, the rider's communication device can begin sending the rider's geolocation at periodic intervals to the vehicle permitting the rider to freely move about while waiting for their ride. The vehicle's navigation recalculates the route to the rider with the updated geolocation information.

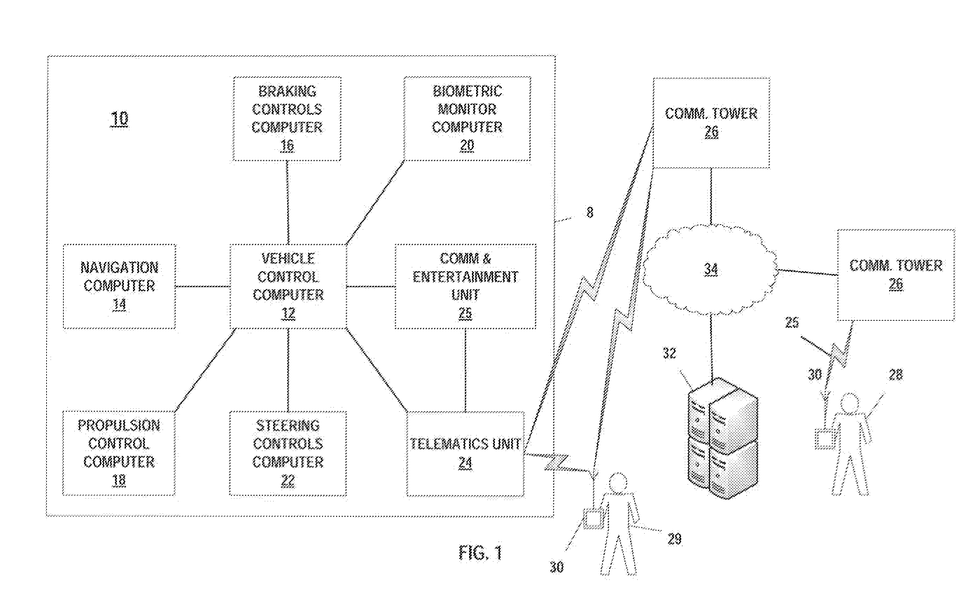

FIG. 1 is block diagram of an exemplary vehicle control system 10 of a vehicle 8, which can be an autonomous vehicle, a semi-autonomous vehicle or a manually operated vehicle. An autonomous vehicle is one is which substantially all operations, i.e., operations relating to propulsion, braking, and steering, are controlled by a control computer 12. A semi-autonomous vehicle is similar to the above described autonomous vehicle, however some but not all of such operations, e.g., operations of propulsion, braking, and steering, are controlled by the vehicle control system 10.

As seen in FIG. 1, various vehicle 8 computers 14-22 can be communicatively connected to and through the control computer 12, e.g., via a vehicle network such as discussed below. The computers 14-22 may each be an electronic control unit (ECU) or the like such as is known. The control computer 12 can include programming to monitor and control various ECUs, their functions and/or other vehicle 8 components. Also seen in FIG. 1, is a telematics unit 24 communicatively coupled to a communication tower, for example, via a radio frequency communications link. The communication tower 26, a communication device 30 and a server 32 are communicatively coupled to a network 34. A rider 28 is in physical contact with a rider device, which can be the communication device 30.

FIG. 1 also illustrates a driver 29 of the vehicle 8 with a communication device 30. The communication device 30 can be linked to the vehicle 8 directly with a Bluetooth® connection through a Bluetooth® radio in the telematics unit 24. Alternatively, the communication device 30 can use a cellular communications network and connect to the communications tower 26. The communications tower 26 can also be connected to the telematics unit 24, completing the communications pathway. Since the driver 29 is equipped with a communication device 30 which is capable of communicating with the vehicle 8 as well as capable of using the cellular network, the driver 29 does not necessarily have to be in the vehicle 8 at all times. The driver 29 merely has to be near (i.e., within a distance at which Bluetooth or the like can operate) the vehicle 8 and ready to respond to a rider 28 request for a ride.

Alternatively, the driver 29 may communicate with the rider 28 and inform the rider 28 that it is time to be picked up, for example, a parent who is acting as the driver 29 can inform their child, the rider 28, that it is time to get picked up. The child would acknowledge the parent's command and go to a rendezvous point to get packed up. Prior to pickup and while the vehicle is navigating to the child's location, the child's communication device 30 can send one or more geolocation updates specifying a geolocation of the child, i.e., a geolocation of the child's communication device 30.

The computer 12, as well as the other computers discussed herein, have at least one processor and typically have a memory, e.g., comprising various types of permanent and transient memory such as are known to store computer instructions, register values, and temporary and permanent variables. Further, the control computer 12 can generally include instructions for exchanging data, e.g., from and to a rider 28 and the driver 29 or the operator of the vehicle 8, for example via a mobile device, a smartphone, a portable computer and/or Human Machine Interface inside the vehicle. A vehicle HMI, as is known, may include one or more of an interactive voice response (IVR) system, a graphical user interface (GUI) including a touchscreen or the like, etc.

The vehicle 8 control computer 12 is typically connected to other computers 14-22 and/or other vehicle 8 ECUs, etc., via a vehicle 8 network. For example, various communications may occur on a Controller Area Network (CAN) bus such as is known. Other wired and wireless communications can be included in the vehicle 8 network, e.g., Ethernet, WiFi, etc. Further, the vehicle can communicate with other networks or vehicles as described below, and may include wireless networking technologies, e.g., cellular, Wi-Fi®, Bluetooth®, Near Field Communication (NFC), wired and/or wireless packet networks, etc.

The control computer 12 is typically connected to a navigation computer 14, a braking controls computer 16, a propulsion control computer 18, a biometric monitor computer 20, a steering computer 22 and a telematics unit 24. The navigation computer 14 can receive, for example, a signal from Global Navigation Satellite System (GNSS) to determine the vehicle 8 location and/or the navigation computer 14 can deploy a dead reckoning system for vehicle 8 location determination. The navigation computer 14 can also plan at least one route to the destination, for example, from a location of the vehicle 8 at the time of receiving a pickup request to a pickup location of the rider 28. The routes can include, for example, turn by turn instructions that the computer 12 can implement if in autonomous mode, or can display the instructions to the Human Machine Interface inside the vehicle or to the screen of the driver 29 mobile device.

The braking control computer 16 can monitor and control the vehicle 8 brakes, as well as other parameters affecting the stopping of the vehicle 8. The braking computer 16, for example, can stop or slow a vehicle 8 when a forward facing sensor detects an object in front of the vehicle 8 by actuating a braking device affixed to the wheels and axles of the vehicle 8, e.g., as is known.

In the present context, a propulsion system can include a powertrain system including an internal combustion engine and/or electric motor, etc. The propulsion control computer 18 can monitor and control the vehicle 8 powertrain, including engines and/or motors.

The biometric monitor computer 20 can receive sensor data related to a vehicle 8 occupant, e.g., the picked-up ride, to determine that the person who was picked up was the indeed the rider 28 who requested the pickup. For example, such received sensor data can be a vehicle camera image from one or more cameras in or on the vehicle 8. The computer 20 can confirm the identity of a rider 28 by matching a facial image received from a stored facial image on the server 32 when the rider 28 requested the ride.

The steering control computer 22 can monitor and control the steering system of the vehicle 8, as well as generate a steering profile which can be sent to the control computer 12 to use for routes and maneuvers. The steering control computer 22, for example, can actuate a change to a steering angle, i.e., turn the vehicle 8 wheels, to navigate a route determined by the navigation computer 14.

The telematics unit 24 or the like is connected to the network 34 via the communications tower 26. The radio frequency communications link 25 can be, for example, a Global System for Mobile Communications (GSM) connection, a General Packet Radio Service (GPRS) connection, Wi-Fi connection, a WiMax connection, or a Long-Term Evolution (4G LTE) connection. Furthermore, the network 34, can be, e.g., the Internet to provide an interconnectivity between the telematics unit 24, the communication device 30 and the server 32.

The rider 28 communications device 30, can be a smartphone, portable computer, wearable device, etc. to send the rider 28 request to be picked up. The communications device 30 can have Global Positioning System (GPS) functionality to acquire the rider 28 geolocation and include the acquired location in the rider 28 request. The location of the rider 28 can be expressed as geo-coordinates such as are known, e.g., latitude and longitude coordinates. The geolocation can be provided by, e.g., a Global Navigation Satellite System (GNSS) receiver (not shown) in the vehicle 8 linked to the navigation computer 14.

A smartphone is typically a mobile telephone such as is known with an advanced mobile operating system which combines features of a personal computer operating system with other features useful for mobile or handheld use. Smartphones typically combine the features of a cellular telephone with those of other popular mobile devices, such as personal digital assistant (PDA), media player and GPS navigation unit. Smartphones can access the Internet and often include a touchscreen interface. Alternatively, as an alternative or backup system, the rider 28 can log in into a web application via browser to send a ride request and get status updates as well.

The smartphone can have a ride pickup mobile app installed. A mobile application (referred to as an “app”) is a computer program designed to run on mobile devices such as smartphones, portable computers, and wearable devices. When the rider 28 wishes to be picked up, the rider 28 launches the ride pickup app and the smartphone sends the request for the ride along with the smartphone's geolocation to the server 32, e.g., according to known messaging technologies.

A portable computer, for example, can be a laptop computer or a tablet computer, and typically includes a display, a keyboard, and/or a touchscreen. The portable computer combines the components, inputs, outputs and capabilities of a desktop computer, including the display screen, speakers, a keyboard, pointing devices (such as a touchpad or trackpad), a processor and memory into a single unit. The portable computer can be equipped with a Network Interface Module (NIM) which allows the portable computer to connect with an external network, for example, the Internet, via the radio frequency communications link 25 using LTE technology. The portable computer can also determine its geolocation, for example, with a built in GPS receiver. To request to be picked up, the rider 28 can launch an installed ride pickup program. The program commands the portable computer to send the request to be picked up along with the portable computer's geolocation to the server 32.

A wearable device is a computer that is incorporated into items of clothing and accessories which can comfortably be worn on the body. A wearable device can perform many of the same computing tasks as mobile phones and laptop computers. The wearable device will have some form of communications capability will allow the wearer device access to the Internet. Examples of wearable devices include watches, glasses, contact lenses, e-textiles and smart fabrics, headbands, beanies and caps, jewelry such as rings, bracelets, and hearing aid-like devices. The wearable device can determine its geolocation, for example, via a built in GPS receiver. The wearable device can be programmed with a preinstalled ride pickup program. For example, to initiate the request to be picked up, a rider 28 could press a button on the wearable device which sends the request for the ride along with the wearable device's geolocation to the server 32.

The server 32 is one or more computer programs and a computing device on which the programs are executable for executing operations as disclosed herein. The server 32 provides operations for other programs or devices, called “clients.” Operations provided by the server 32 are often called “services”, and can include sharing data or resources among multiple clients, or performing computation for a client. The server 32, for example, can execute a ride request program that processes the rider 28 request for a ride and forwards the request to the vehicle 8 over the network 34. The ride request program, for example, can handle the initial request to be picked and all additional communications exchanges between the rider 28 and the vehicle 8. The server 32 can include or be connected to a database that stores information about the rider 28, for example, the rider 28 credit card information, the facial image of the rider 28 and previous pick up and drop off locations.

The server 32 can also be connected to weather and traffic services which provide up to date information about changing weather conditions, road closures due to accidents and highways to avoid due to construction.

Process Flows

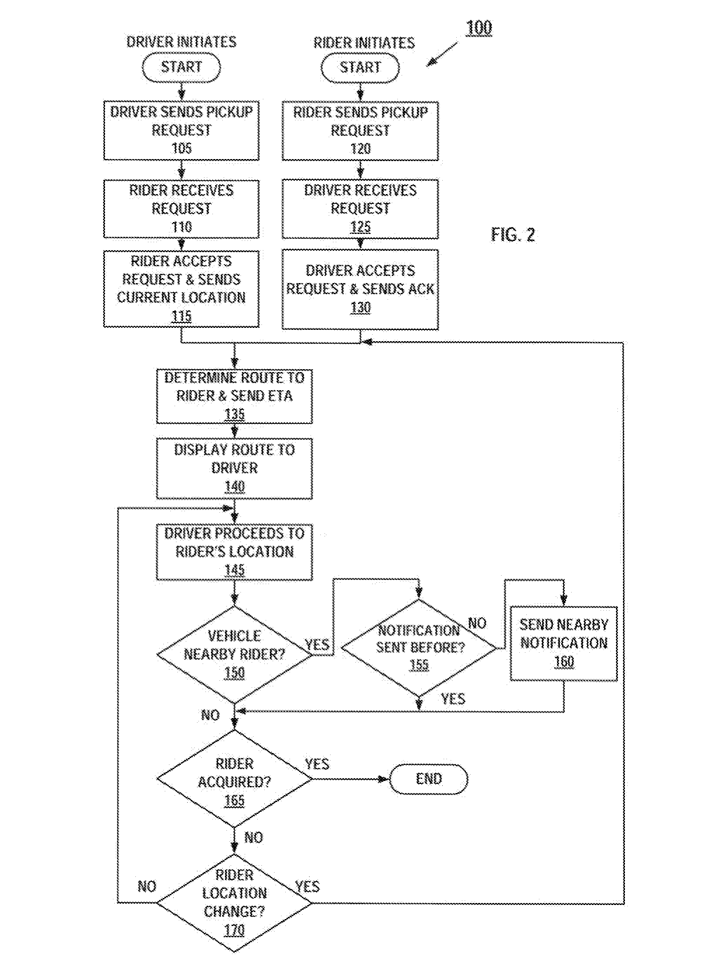

FIG. 2 is a flow chart illustrating an exemplary process 100 that can be executed according to programming in a vehicle 8 computer 12 to receive a request from a rider 28 along with updated current locations of the rider 28, and to subsequently navigate to the rider 28. Alternatively, the driver 29 can initiate the pickup request and send a pickup notice to the rider 28, who in turn acknowledges the pickup notice and automatically send updated current locations of the rider 28.

The process 100 can begin in a block 105 in which the driver 29 of the vehicle 8 initiates the pickup request, for example, a parent alerting their child that it's time to be picked up or alternatively, the process 100 can begin in a block 120 when the rider 28 initiates the pickup request.

Next, in a block 110, the driver 29 request can receive the request directly from the rider 28 communication device 30 or the request can be processed through the server 32 and forwarded to the rider 28.

Next in a block 115, the rider 28 acknowledges the request and sends an acknowledgement message accepting the driver 29 request along a geolocation provided from the communication device 30, for example, in a known manner using the position obtained from a Global Navigation Satellite System (GNSS). The locations of the rider 28 and the vehicle 8, as is known, can both be expressed as coordinates, e.g., latitude and longitude coordinates, referred to herein as a “geolocation.” The need for an accurate pickup location of the rider 28 can vary by the rider 28 locale, for example, in a crowded city the accuracy of the pickup location is more important than a pickup location on a rural road. In the city it is often difficult for the rider 28 determine which vehicle is their pickup vehicle due to the sheer number of vehicles in the city. In the country or urban setting, it would be easier for the rider 28 to determine which vehicle is their ride, as there are considerably less vehicles in the country. Therefore, in the city the computer 12 can default to a pickup proximity radius of 10-20 meters when determining the rider 28 pickup location. In the rural setting, the computer 12 can change the pickup proximity radius to 30-40 meters. However, the pickup proximity radius could be changed based on conditions, e.g., decreased by a fractional factor such as ½ (e.g., 10 meters becomes 5 meters) in the absence of daylight, in the presence of precipitation, etc.

In the block 120, the rider 28 sends a request for a pickup using the rider 28 communication device 30, for example, a rider 28 smartphone to send the request to the server 32 via the communication tower 26 and the network 34. The request may include the rider's current location, a destination, a payment method and a facial image of the rider 28.

Next, in the block 125, the driver 29 receives the request to be picked up, for example, via the server 32. The request includes the geolocation which can be obtained on the mobile device from the GNSS.

Next, in a block 130, the driver 29 accepts the rider 28 request and sends an acknowledgement to the rider 28.

Next, a block 135, which can follow in the blocks 115 130 170, is executed. In the block 135, the computer 12, working in conjunction with the navigation computer 14, a set of trip preferences of the driver 29 and possibly traffic information provided by the server 32, at least one route is determined (or, in second or subsequent iterations of the block 135, the process will re-determine the route or routes) from the vehicle 8 location to the rider 28. More precisely, the route typically will terminate at the geolocation of the rider 28 communication device 30. The set of trip preferences of the driver 29 can include, for example, whether the driver 29 wants a shortest route, a quickest route, a scenic route, etc. The set of trip preferences can also include a time of day setting, for example, the driver 29 may wish to travel along the coast if the trip were to occur at sunset. After the route is determined, the computer 12 can send an estimated time of arrival (ETA) to the rider 28 along with a ride portfolio. The ride portfolio can be a listing of the route details which can be useful to the rider 28, for example, the ride portfolio can inform the rider 28 that the vehicle 8 will be coming from the west and that the rider 28 should wait on the north side of the street for their pickup at 7:00 p.m. The information in the ride portfolio permits the rider 28 to better position him or herself for pickup and allows the rider 28 to avoid any harsh environmental factors, for example, rain or snow until just before the ETA. Additionally, after an initial request for pickup and subsequent acknowledgement from the driver, the geolocation of the rider 28 can be periodically resent to the vehicle 8 permitting the route to be updated due to the rider 28 possibly changing his or her location.

Next, in a block 140, the computer 12 working with the navigation computer 14, causes the route to be displayed in the vehicle, for example, on the Human Machine Interface. The navigation computer 14 can also provide announced turn-by-turn directions on the vehicle 8 interactive voice response (IVR) system. Additionally, the route can be uploaded to the communication device 30 of the rider.

In a block 145, which can be entered from one of the blocks 140, 170, the computer 1:2 confirms that the driver 29 has started the trip to pick up the rider 28.

Next in a block, 150 a determination is made if the vehicle 8 is proximate to the rider 28. A determination is made by the computer 12 of a proximity of the vehicle 8 to the rider 28. A proximity can be a predetermined radius, e.g., 50 meters, 100 meters, etc. For example, the vehicle 8 can be within 100 meters of the rider 28, and can then be deemed to be proximate to the rider 28. Further, the predetermined distance that defines whether the vehicle 8 is proximate to the rider 28 can, in some implementations, be adjusted by the computer 12. For example, a proximate distance could default to a distance deemed to be safe for a vehicle 8 to stop in a parking lot, e.g., 10 meters, 100 meters, etc. However, a proximate distance could be changed based on conditions, e.g., decreased by a fractional factor such as ½ (e.g., 1.00 meters becomes 50 meters) in the absence of daylight, in the presence of precipitation, in the presence of traffic above a predetermined density (i.e., a number of vehicles passing a point in a road in a period of time), etc. Similarly, a proximate distance could be increased based on one or more factors, e.g., the vehicle computer 12 could determine based on map data that a setting was rural, to increase the proximate distance by a factor or 1.5. If the vehicle 8 is nearby, next a block 155 is executed, else next a block 165 of the process is executed.

Next in the block 155, the computer 12 determines if it had already sent a “nearby notification” to the rider 28. If the computer has sent the nearby notification, next in the block 165 is executed, else next a block 160 is executed to send the nearby notification.

Next in the block 160, the computer 12 sends the nearby notification to the rider 28, for example, as a text message to the rider 28 smartphone.

Next in the block 165, which can follow one of the blocks 150, 155, 160, the computer 12 determines if the rider 28 was picked up, for example, the location of the rider 28 and the location of the vehicle 8 are the same or have a proximate location near each other for a time interval, for example, the computer 12 determines the rider 28 and the vehicle 8 have been at the same location for 120 seconds, thus ensuring the rider 28 is in the vehicle 8. The time interval can be adjusted to compensate for the rider 28 physical characteristics, for example, an elderly person can require more time to get into the vehicle 8 and the time interval can be extended to 240 seconds to ensure the rider 28 makes it safely onboard the vehicle 8. In addition to matching locations, the computer 12 can match a movement of the rider 28 to a movement of the vehicle 8, for example, the rider 28 and the vehicle 8 should be both moving at the same rate of speed in the same direction indicating the rider 28 is onboard the vehicle 8.

Another method to verify that the rider 28 has been picked up is to deploy any of the vehicle 8 imaging devices, such as a camera and capture a first image of the rider 28 and verify that image to a second image the rider 28 included in their ride request. The second image can also have been retrieved from memory of the computer 12 or from the server 32.

Still yet another technique to verify the rider 28 is onboard is to verify the rider 28 communication device 30 using a radio frequency fingerprint analysis technique, for example, the communication device 30 transmitted Media Access Control (MAC) address(es) can be verified by the vehicle 8 telematics unit 24 by monitoring the presence of the rider's 28 communication device's 30 MAC address. The MAC address is a hexadecimal number that is the public, unique, radio “call sign” for each wireless device used by most IEEE 802 technologies (WiFi, Bluetooth, ZigBee etc.). The MAC address(es) of the rider 28 can be sent when the rider 28 was making the pickup request or it can be retrieved from memory of the computer 12 or from the server 32. If the rider 28 was picked up, the process 100 ends, else the process continues to a block 170.

Next in the block 170, the computer 12 determines if the rider 28 has changed their geolocation from an updated geolocation message which can be continuously sent from the rider 28 communication device 30 and eventually received at the telematics unit 24 of the vehicle 8. In this context, the term continuously can mean at a set interval, for example, once every minute or whenever the communication device 28 has determined it has moved more than 20 meters from a previously sent geolocation. Continuously can also mean any of the subsequent geolocation messages sent after the initial pickup request is sent, and can continue until the rider 28 is picked up. Alternatively, the computer 12 can also request that the communication device 28 to send the updated geolocation message pro re nata or until the rider 28 is picked up.

Since world governments are committed to providing GPS to the civilian community at a standard performance level, for example, as specified in the GPS Standard Positioning Service (SPS) Performance Standard. A GPS signal in space will provide a “worst case” pseudorange accuracy of 7.8 meters at a 95% confidence level. Pseudorange accuracy is the calculated accuracy of the distance from a GPS satellite to a GPS receiver. The communication device 30 internal GPS receiver can report the communication device 30 has moved over 7 meters while the communication device 30 is stationary. Therefore, the communication device 30 should only report that its position has changed when the communication device 30 determines it has moved, for example, more than 20 meters to eliminate any GPS position reporting issues. The distance can be increases or decreases depending on the accuracy of the positioning determination. If the rider 28 has changed geolocation, the process 100 returns to the block 135 for a route recalculation, else the process returns to the block 145 to continue on the vehicle 8 current route.

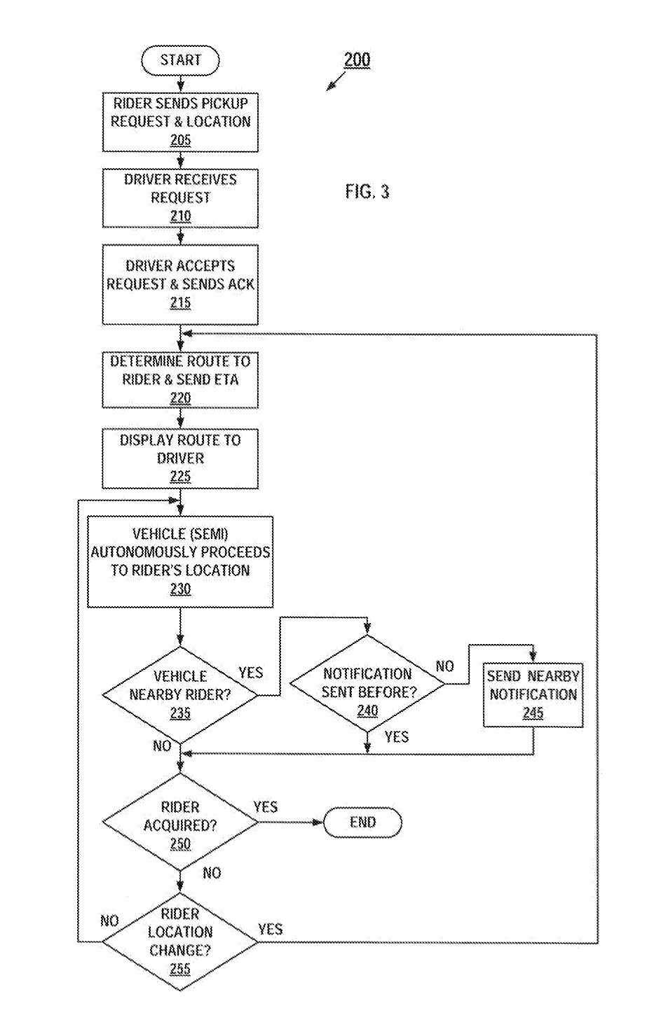

FIG. 3 is a flow chart illustrating another exemplary process 200 that can be executed according to programming in a vehicle 8 computer 12 to receive a request from a rider 28 along with the current location of the rider 28, and to subsequently autonomously drive to the rider 28 location. The rider 28 communication device 30 periodically sends updates to the driver's current location, permitting the vehicle 8 computer 12 to recalculate the route to the rider 28. The process 200 further includes sending a nearby message to the rider 28 mobile device when the vehicle 8 is proximate to the rider 28.

The process 200 begins in a block 205, which is identical to the block 105 of the process 100. Additionally, blocks 210, 215, 220, 225, 235, 240, 245, 250 and 255 are identical to in the blocks 125, 130, 135, 140, 150, 155, 160, 165 and 170.

In the block 230, the computer 12 operated the vehicle 8 in an autonomous mode which causes actuation of vehicle 8 components to execute the route to the current location of the rider 28. For example, each respective computer of the system 10 is issued instructions from the control computer 12 to control each of a vehicle 8 propulsion system, a steering system, and braking system to navigate and maneuver the vehicle 8 to the geolocation of the rider 28.

### CONCLUSION

As used herein, the adverb “substantially” modifying an adjective means that a shape, structure, measurement, value, calculation, etc. may deviate from an exact described geometry, distance, measurement, value, calculation, etc., because of imperfections in the materials, machining, manufacturing, sensor measurements, computations, processing time, communications time, etc.

Computing devices such as those discussed herein generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, C#, Visual Basic, Python, Java Script, Perl, HTML, PHP, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system, comprising a computer having a processor and a memory, the memory storing instructions executable by the processor such that the computer is programmed to:
receive a pickup request including a location of a communication device of a rider;
determine a route to the location of the communication device, based on a location of a vehicle and the location of the communication device;
continuously receive an updated current location from the communication device; and
update the route based on the updated current location of the communication device.

2. The system of claim 1, wherein the computer further controls each of vehicle propulsion, steering, and braking.

3. The system of claim 1, wherein the computer is further programmed to display the route to the current location on a graphical user interface (GUI).

4. The system of claim 1, wherein the pickup request includes at least a destination and a facial image of the rider.

5. The system of claim 1, wherein the computer is further programmed to send an acknowledgement message to the communication device of the rider.

6. The system of claim 1, wherein the computer is further programmed to:
calculate an estimated time of arrival (ETA) of the vehicle at location of the rider; and
send at least the ETA and a route detail to the communication device of the rider.

7. The system of claim 1, wherein the computer is further programmed to:
determine if the vehicle is within a predetermined distance of the communication device, and, based upon the determination, send a message to the communication device.

8. The system of claim 1, wherein the communication device is one of a smartphone, a portable computer and a wearable device.

9. The system of claim 1, wherein the computer is further programmed to determine if the rider is in the vehicle by comparing at least the location of the vehicle, a movement of the vehicle and a known Media Access Control (MAC) address of the communication device of the rider to a location of the communication device, a movement of the communication device and a detected MAC address of the communication device.

10. The system of claim 2, wherein the computer is further programmed to confirm an identity of the rider by comparing a stored facial image of the rider to a vehicle camera image.

11. A method, comprising:
receiving a pickup request including a current location of a communication device of a rider;
determining a route to the current location of the communication device, based on a geolocation of a vehicle and the current location of the communication device;
displaying the route to a driver;
receiving a continuously updated current location from the communication device of the rider; and
updating the route based on the updated current location of the communication device of the rider.

12. The method of claim 11, further comprising controlling each of vehicle propulsion, steering, and braking.

13. The method of claim 11, further comprising sending an acknowledgement message to the communication device of the rider.

14. The method of claim 11, further comprising determining if the vehicle is within a predetermined distance of the communication device of the rider, and, based upon the determination, sending a message to the communication device.

15. The method of claim 11, wherein the communication device is one of a smartphone, a portable computer and a wearable device.

16. The method of claim 11, further comprising determining if the rider is in the vehicle by comparing at least the location of the vehicle, a movement of the vehicle and a known Media Access Control (MAC) address of the communication device of the rider to a location of the communication device of the rider, a movement of the communication device and a detected MAC address.

17. The method of claim 11, further comprising confirming an identity of the rider by comparing a stored facial image of the rider to a vehicle camera image.

18. The method of claim 11, further comprising displaying the route to the current location on a graphical user interface (GUI).

19. An vehicle location system, comprising:
means for receiving a pickup request including a current location of a communication device of a rider;
means for determining a route to the current location of the communication device of the rider, based on a geolocation of the vehicle and the current location of the communication device;
means for continuously receiving an updated current location of the communication device; and
means for updating the route based on the updated current location of the communication device.

20. The system of claim 19, further comprising means for controlling each of vehicle propulsion, steering, and braking to enable the vehicle to proceed along the route to the current location of the rider.
